(19) United States
(12) Patent Application Publication
(10) Pub. No.: US 2026/0052584 A1
(43) Pub. Date: Feb. 19, 2026

(54) NETWORK-INITIATED PROTOCOL DATA UNIT SET HANDLING MODE SWITCHING

(71) Applicant: Apple Inc., Cupertino, CA (US)

(72) Inventors: Ping-Heng Kuo, London (GB); Fangli Xu, Beijing (CN); Ralf Rossbach, Munich (DE)

(73) Assignee: Apple Inc., Cupertino, CA (US)

(21) Appl. No.: 19/100,542

(22) PCT Filed: Aug. 3, 2022
(86) PCT No.: PCT/CN2022/109991

§ 371 Date: Jan. 31, 2025

(51) Int. Cl. H04W 76/10; H04W 72/231

(52) U.S. Cl. CPC H04W 76/10; H04W 72/231

(57) ABSTRACT

The present application relates to devices and components including apparatus, systems, and methods for switching protocol data unit set handling modes.

### TECHNICAL FIELD

This application relates generally to wireless communication, and in particular relates to network-initiated protocol data unit set handling mode switching.

### BACKGROUND

Third Generation Partnership Project (3GPP) Technical Specifications (TSs) define standards for wireless networks. These TSs describe aspects related to signaling extended reality (XR) traffic throughout systems that incorporate wireless networks.

### BRIEF DESCRIPTION OF THE DRAWINGS

FIG. 1 illustrates a network environment in accordance with some embodiments.

FIG. 2 illustrates a user equipment in accordance with some embodiments.

FIG. 3 illustrates a media access control-control element in accordance with some embodiments.

FIG. 4 illustrates a signaling diagram in accordance with some embodiments.

FIG. 5 illustrates an operational flow/algorithmic structure in accordance with some embodiments.

FIG. 6 illustrates another operational flow/algorithmic structure in accordance with some embodiments.

FIG. 7 illustrates another operational flow/algorithmic structure in accordance with some embodiments.

FIG. 8 illustrates a user equipment in accordance with some embodiments.

FIG. 9 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated.

Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

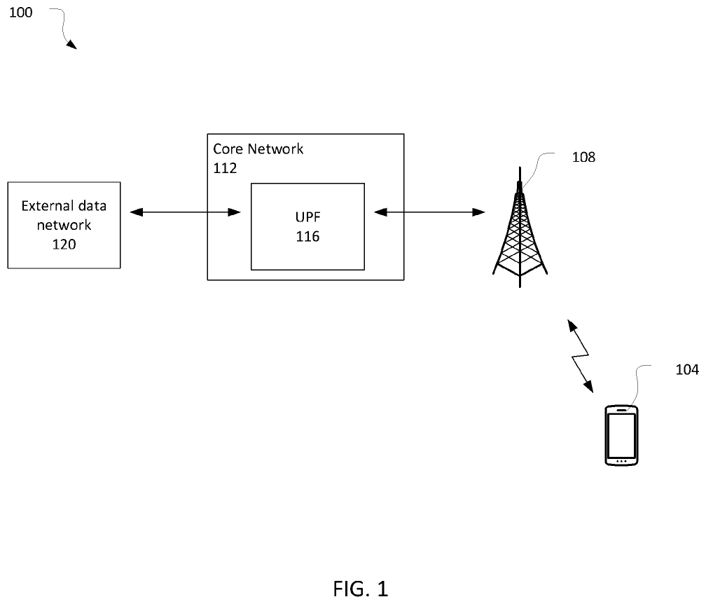

FIG. 1 illustrates a network environment 100 in accordance with some embodiments. The network environment 100 may include a user equipment (UE) 104 communicatively coupled with a base station 108 of a radio access network (RAN). The UE 104 and the base station 108 may communicate over air interfaces compatible with 3GPP TSs such as those that define a Fifth Generation (5G) new radio (NR) system or a later system.

The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UEs 104 via the base station 108. These functions may include managing subscriber profile information, subscriber location, authentication of services, or switching functions for voice and data sessions.

The core network 112 may include a user plane function (UPF) 116 that provides for routing and forwarding of user plane packets between the base station 108 and an external data network 120. The BS 108 may receive uplink packets from the UE 104 through the DRBs and may transmit the uplink packets to the UPF 116 through a general packet radio service (GPRS) tunneling protocol-user plane (GTP-U) tunnel. The UPF 116 may remove the packet headers and forward the packets to the external data network 120.

The UPF 116 may map downlink packets arriving from an external data network onto specific quality of service (QOS) flows belonging to specific protocol data unit (PDU) sessions before forwarding to the BS 108. The BS 108 may map the traffic to the appropriate DRBs for delivery to the UE 104.

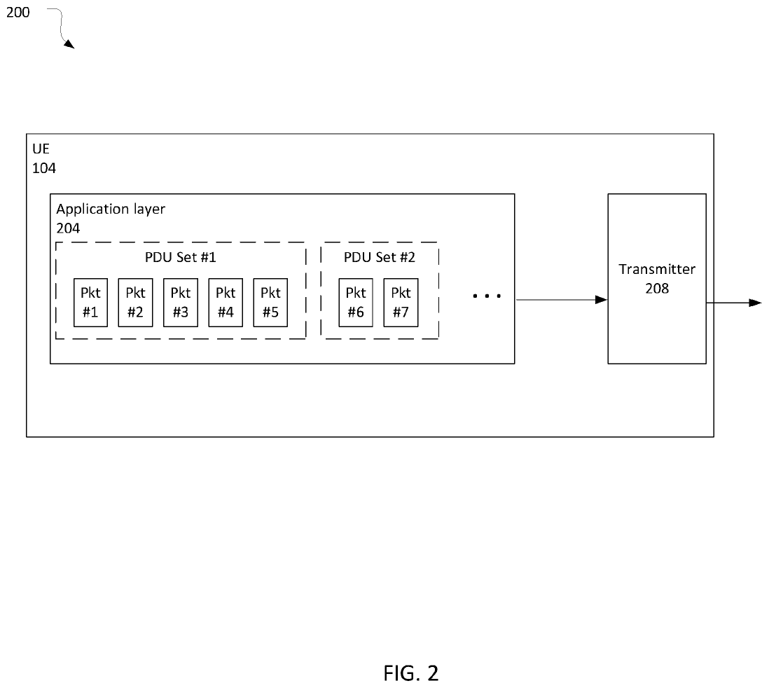

FIG. 2 illustrates aspects of the UE 104 in further detail in accordance with some embodiments. The UE 104 may include an application layer 204 that generates application traffic to be transmitted to another device through the network environment 100. In some embodiments, the application layer 204 may have an XR application that generates XR traffic. However, embodiments are not limited to XR use cases.

For XR and other services, the application layer 204 may generate PDU sets, with individual PDU sets comprising one or more packets. A packet, which may also be referred to as a PDU, may be an Internet protocol (IP) packet or a non-IP packet. As shown, PDU set #1 may include packets #1-#5, while PDU set #2 includes packet #6 and #7 . Each PDU set may be mapped to a different QoS flow.

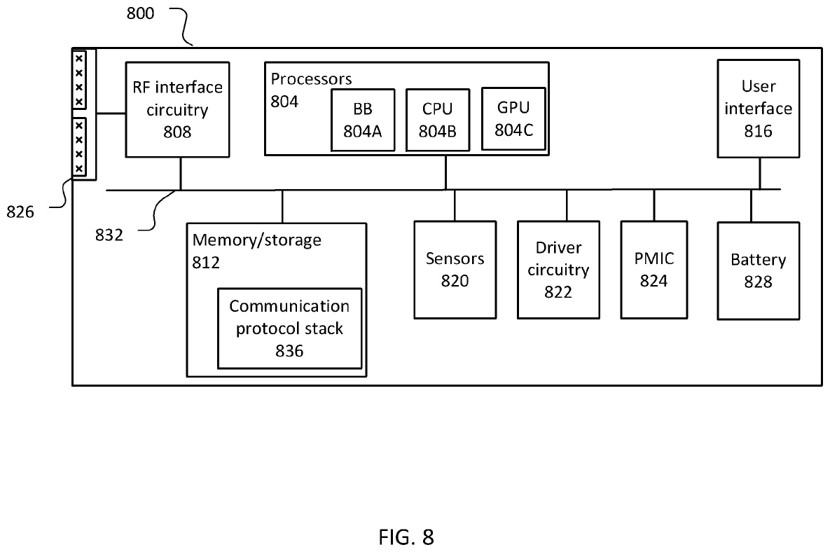

The PDU sets may be provided to a transmitter 208 of the UE 104. The transmitter 208 may be configured to execute a communication protocol stack, for example, communication protocol stack 836 of FIG. 8, to facilitate communication via the network environment 100. The transmitter 208 may implement layer 2 (L2) and layer 1 (L1) functionality. At the L2 level, the transmitter 208 may include a service data adaptation protocol (SDAP) layer, a packet data convergence protocol (PDCP) layer, a radio link control (RLC) layer, and a media access control (MAC) layer. At the L1 level, the transmitter 208 may include a physical (PHY) layer. Briefly, the SDAP layer may manage QoS flow handling between the QoS flows and the DRBs. The PDCP layer may manage robust header (de) compression and security between DRBs and RLC channels. The RLC layer may manage (re-)segmentation and error correction through automatic repeat request (ARQ) between logical channels and RLC channels. The MAC layer may manage scheduling/priority handling, (de)multiplexing, and hybrid automatic repeat request (HARQ) processes between logical channels and transport channels. And the PHY layer may manage the processing of the physical data and control channels.

Upon receiving uplink traffic, the UPF 116 may identify a PDU set based on a PDU set sequence number (SN), a starting/ending PDU of the PDU set, a PDU SN within a PDU set, or a number of PDUs within a PDU set.

The QoS flow may be identified using a QoS flow identifier (ID) and each PDU set within a QoS flow may be identified using a PDU set SN. Each QoS flow may be used to deliver one or more PDU sets.

The UPF 116 may further identify information relating to each PDU set. For example, a PDU set may have a PDU set importance that allows certain PDU sets to be processed with a higher priority. In another example, a PDU set may have a PDU set dependency that provides an inter-dependent relationship among a group of PDU sets.

The UPF 116 may obtain information regarding the PDU sets through non-access stratum (NAS) signaling with the UE 104. The UPF 116 may provide this information to the RAN, for example, the base station 108.

A number of QoS parameters may be defined in the network environment 100 for QoS handling based on PDU sets. A QoS parameter may include a PDU set delay budget (PSDB) may be set to provide an upper bound for a time that a PDU set may be delayed between the UE 104 and a network node. In some embodiments, if a PDU set is not received within the PSDB, it may be discarded. In other embodiments, it may still be used. A QoS parameter may include a PDU set error rate (PSER) that defines an upper bound for a rate of non-congestion related PDU set losses. A QoS parameter may include an indication of whether all PDUs are needed for usage of the PDU set by an application layer at the receiver. A QOS parameter may include a PDU set priority that indicates a priority in scheduling resources among QOS flows.

In various embodiments, the UE 104 may be configured to operate in a best-user experience PDU set handling mode (referred to herein as “mode 1”) or a resource-saving PDU set handling mode (referred to herein as “mode 2”). While in mode 1, the transmitter 208 may strive to deliver all packets of a PDU set in order to achieve the best quality of experience to the user. Operation in this mode prioritizes user experience over usage of radio resource and device power.

While in mode 2, the transmitter 208 may make its best efforts to deliver a threshold number of packets in the PDU set (for example, M packets). The threshold number may be a minimum required number of packets for the PDU set to be considered received successfully. Upon delivery of the threshold number of packets, the transmitter 208 may intentionally discard the remaining pending packets in the PDU set in order to save radio resources or device power.

The transmitter 208 may intentionally drop packets in mode 2 in one or more of the following instances. In a first instance, the transmitter 208 may drop packets of a PDU set after the M packets are successfully delivered. The transmitter 208 may rely on acknowledgments (ACKs) or negative acknowledgements (NACKs) fed back from a receiver to determine that the M packets are successfully delivered. In a second instance, the transmitter 208 may drop packets of a PDU set after the M packets are submitted to a lower layer. For example, the transmitter 208 may drop packets after the PDCP layer delivers the M packets of the PDU set to the RLC layer, the MAC layer or the PHY layer. In a third instance, the transmitter 208 may drop packets of a PDU set after all essential packets of the PDU set are successfully delivered. The essential packets may be a subset of the threshold M packets, or may be defined independently therefrom. The transmitter 208 may rely on ACKs/NACKs fed back from the receiver to determine that the essential packets are successfully delivered. In a fourth instance, the transmitter 208 may drop packets of a PDU set after all essential packets are submitted to a lower layer. For example, the transmitter 208 may drop packets after the PDCP layer delivers the essential packets of the PDU set to the RLC layer, the MAC layer or the PHY layer. In a fifth instance, the transmitter 208 may drop packets of a PDU set if the elapsed time since the arrival of a first packet of the PDU set has reached a threshold time. This may be controlled by a timer that is started upon first receipt of the first packet of the PDU set by layer of the transmitter 208 (for example, PDCP, RLC, MAC, or PHY layer). In a sixth instance, the transmitter 208 may drop packets of a PDU set if a remaining time until expiration of the PSDB is lower than a threshold time.

Mode 2 operation may be useful in instances in which streamed traffic may tolerate loss of certain packets (or a certain number of packets) from a PDU set with little to no detriment to the experience of a user that consumes the services, for example, a user of XR services.

Embodiments of the present disclosure describes dynamic switching between the two PDU set handling modes in order to obtain a desired balance between resource efficiency and user experience.

In some embodiments, the transmitter 208 may be configured with a default or an initial setting of the PDU set handling mode. The default or initial setting may be preconfigured or otherwise predefined by a 3GPP TS, for example. In some embodiments, there may be more than one type of PDU set that is to be conveyed on a DRB. In these embodiments, a default/initial setting may be provided for each of the plurality of different types of PDU sets. For example, a first type of PDU set may have a first priority or importance level, and a second type of PDU set may have a second priority or importance level that is less than the first priority or importance level. In this example, the default/initial setting for the first type of PDU set may be mode 1, while the default/initial setting for the second type of PDU set may be mode 2. While embodiments described herein refer to PDU sets being type 1 or type 2, various embodiments may include a number of different types based on importance level or some other characteristic of the PDU set.

If a default/initial setting of the PDU set handling mode is not provided, the transmitter 208 may default to operating in mode 1.

In some embodiments, the base station 108 may preconfigure the PDU set handling mode for a DRB at the UE 104. Additionally/alternatively, the base station 108 may configure a mode of switching between the PDU set handling modes for a DRB.

Configuration information that defines the default/initial setting or mode switching may be provided in a new field in an information element (IE) of an RRC message. For example, The PDCP-config IE of the RRC configuration message may provide a default/initial setting or mode switching information. Other IEs or messages may be used in other embodiments.

While the above embodiments describe configuration of default/initial setting and mode switching on a DRB basis, other embodiments may additionally/alternatively configure these parameters per QOS flow.

In some embodiments, the PDU set handling mode switching may be an implementation option of the transmitter 208. In this case, configuration of this parameter may not be necessary.

In some embodiments, the switching of the PDU set handling mode may be initiated by the network. For example, the base station 108 may instruct the UE 104 to switch an operation mode of a DRB in a dynamic manner. The base station 108 may decide to send the instruction based on detection of a trigger condition. The trigger condition may be based on one or more events that are pre-defined (for example, by 3GPP TS) or defined as part of a network implementation. The trigger events may be related to a RAN loading status, an interference status, a channel status, a location of the UE 104, or a mobility of the UE 104.

For example, if the base station 108 determines the RAN is heavily loaded (for example, loaded over a threshold), the base station 108 may seek to reduce overall network traffic by switching the UE 104 from mode 1 to mode 2. If, on another hand, the base station 108 determines that there is a large amount of interference or the channel has a quality below a desired threshold, the base station 108 may instruct the UE 104 to switch from mode 2 to mode 1.

The instruction for performing a PDU set handling mode switch for at least one DRB may be sent by an RRC reconfiguration message or a downlink MAC control element (CE). The instruction may be applicable to certain types of PDU sets. For example, if one DRB is used to convey both type 1 and type 2 PDU sets, the PDU set handling mode may be switched for type 1 only, type 2 only, or both type 1 and 2.

Upon receiving the instruction, the UE 104 may switch PDU set handling modes in the affected DRBs as instructed.

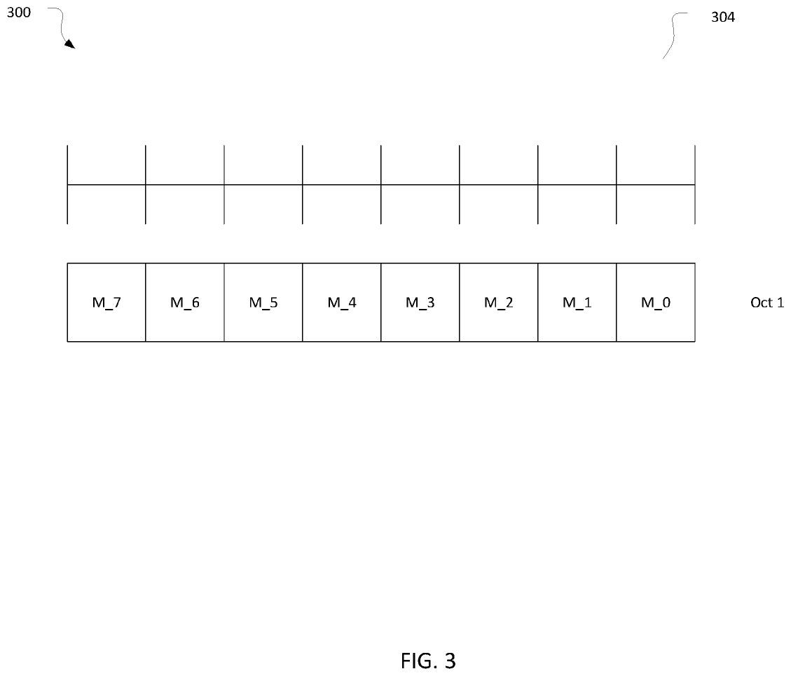

FIG. 3 illustrates a MAC CE 300 that may be used to convey a switch instruction for PDU set handling modes in accordance with some embodiments. In this embodiments, the MAC CE 300 may include a bitmap in which each bit represents a DRB.

The value of a particular bit may correspond to whether the corresponding DRB should operate in mode 1 or mode 2.

In another embodiment, the MAC CE may convey a switch instruction by including one or more DRB identifiers (IDs). Upon receiving this switch instruction, the UE 104 may determine that it is to perform a PDU set handling mode switch with respect to each of the DRBs associated with IDs in the MAC CE.

While these embodiments describe signaling to switch handling mode for all PDU sets of a given DRB, other embodiments may use similar signaling to switch only PDU sets of a particular type. Further, similar signaling may be used to switch all (or a subset of) PDU sets associated with a particular QoS flow.

In some embodiments, the switching of the PDU set handling mode may be initiated by the UE 104. This may happen by the UE 104 making a recommendation/request for the switch and waiting for the resulting instruction from the network, or by proactively making the switch with or without a notification of the switch being sent to the network.

Proactively making the switch, as used herein, refers to the UE 104 making the switch without receiving an explicit instruction from the base station to do so.

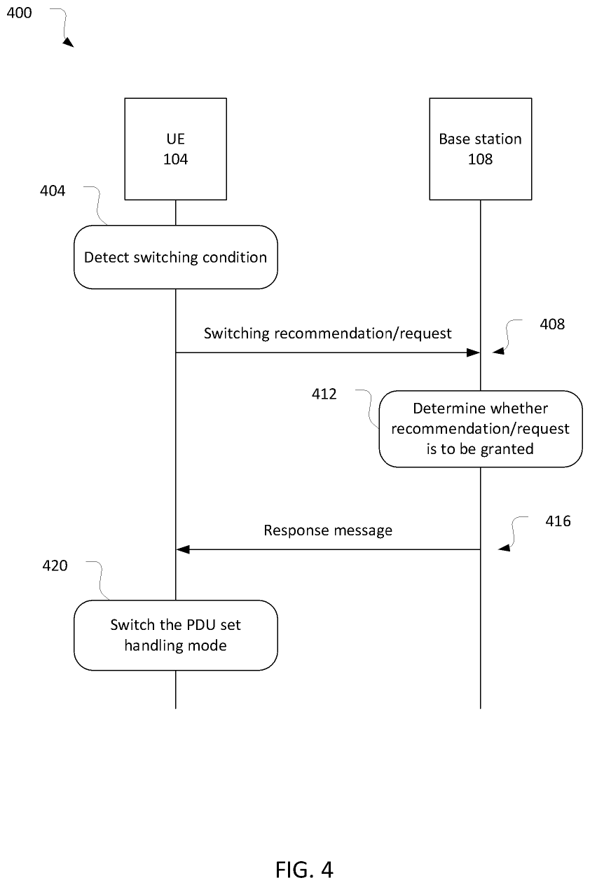

FIG. 4 provides a signaling diagram 400 for a UE-initiated mode switch in accordance with some embodiments.

The signaling diagram 400 may include, at 404, the UE 104 detecting a trigger condition in which switching from the current PDU set handling mode is desired. The trigger condition may be based on events detected by the UE 104. The detected events may represent changed conditions that would be better addressed by a different PDU set handling mode. For example, if the underlying events are indicative of an overutilization of platform or network resources, the system may be best served by switching to mode 2, which prioritizes resource conservation. On the other hand, if the underlying events are indicative of potentially compromised quality of experience, the system may be best served by switching to mode 1, which prioritizes delivering the traffic with the highest quality of experience. For example, the UE 104 may seek to switch to mode 2 if it detects one or more of the following conditions: its battery drops below a threshold level; its mobility exceeds a threshold level; one or more observed channel metrics (for example, reference signal receive power (RSRP), reference signal receive quality (RSRQ), signal-to-interference-plus-noise ratio (SINR)) drop below a corresponding threshold level; observed interference level exceeds a threshold level; or a location of the UE 104 is within a certain region (e.g., cell edge). In some embodiments, one or more of these conditions may alternatively prompt a switch to mode 1.

After detecting the trigger condition, the signaling diagram 400 may include the UE 104 sending a recommendation/request for the mode switch at 408. The recommendation/request for the PDU set handling mode switching may be for at least one DRB (or QoS flow) or type of PDU set within a DRB/QOS flow. The recommendation may be sent on a MAC CE or an RRC message. For example, the UE 104 may send the recommendation/request to the base station 108 in UE assistance information (UAI) provided in a UE assistance information (UEAssistanceInformation) message. Except as otherwise described herein, the UEAssistanceInformation message may be similar to that described in 3GPP TS 38.331 v17.1.0 (2022-07-19). The recommendation/request may include one or more of the following: targeted DRB(s) (or QoS flow(s)) of the recommendation/request; targeted type of PDU set of the recommendation/request; targeted mode of operation; and reason for PDU set handling switching.

The signaling diagram 400 may include the base station 108 determining whether the recommendation/request is to be granted at 412. In some embodiments, the determination of whether it is to be granted may be based on additional conditions that may be detected by the base station 108. These additional considerations may be similar to the trigger conditions discussed above with respect to the network-initiated handling mode switch.

The signaling diagram 400 may further include the base station 108 sending a response message at 416 to indicate whether the recommendation/request is granted. In the event the recommendation/request is granted, the response message 416 may be an RRC message or MAC CE with a switch instruction similar to that discussed above with respect to the network-initiated handling mode switch. In this case, the signaling diagram 400 may further include, at 420, the UE 104 switching the PDU set handling mode for the DRB/QOS flow/PDU set type as indicated in the response message.

In some embodiments, the UE 104 may be preconfigured to autonomously switch the PDU set handling mode of a DRB/QOS flow/PDU set type when certain conditions are met.

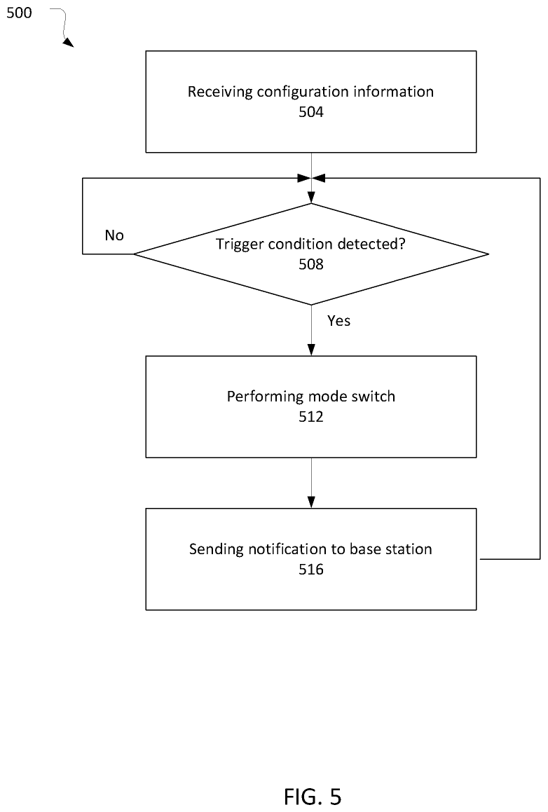

FIG. 5 provides an operation flow/algorithmic structure 500 for a UE-initiated mode switch based on detecting preconfigured conditions in accordance with some embodiments. The operation flow/algorithmic structure 500 may be performed by a UE such as UE 104, UE 800; or components thereof, for example, processors 804.

The operation flow/algorithmic structure 500 may include, at 504, receiving configuration information. The configuration information may be received from a base station and may provide an initial PDU set handling mode for at least one DRB/QOS flow/PDU set type. The configuration information may additionally/alternatively configure one or more trigger conditions (with threshold levels as appropriate) and an associated switch from a first PDU set handling mode to a second PDU set handling mode. The trigger conditions may be based on events detectable by the UE similar to those discussed above with respect to FIG. 4.

The operation flow/algorithmic structure 500 may further include, at 508, detecting whether a trigger condition is met. As discussed above, a trigger condition may be met when one or more events, configured at 504, are detected by the UE. If the trigger condition is not detected, the UE may continue to monitor for the configured events.

If the trigger condition is detected at 508, the operation flow/algorithmic structure 500 may advance to performing the mode switch at 512. The mode switch, which may be associated with the particular detected trigger condition as configured at 504, may switch operation to PDU set handling mode 1 or PDU set handling mode 2 for some or all of the PDU sets of a particular DRB or QoS flow in order to better address the underlying events.

In some embodiments, the operation flow/algorithmic structure 500 may further include sending a notification of the mode switch to the base station at 516. This notification may be sent as an uplink MAC CE. The MAC CE may include a bitmap similar to that shown and described in FIG. 3, where each bit (with value of ‘0’ or ‘1’) indicates whether the PDU set handling mode has been switched by the UE for a DRB/QOS flow/PDU set type. In other embodiments, the notification may include an identifier associated with the DRB/QOS flow/PDU set type for which the operation mode has been switched.

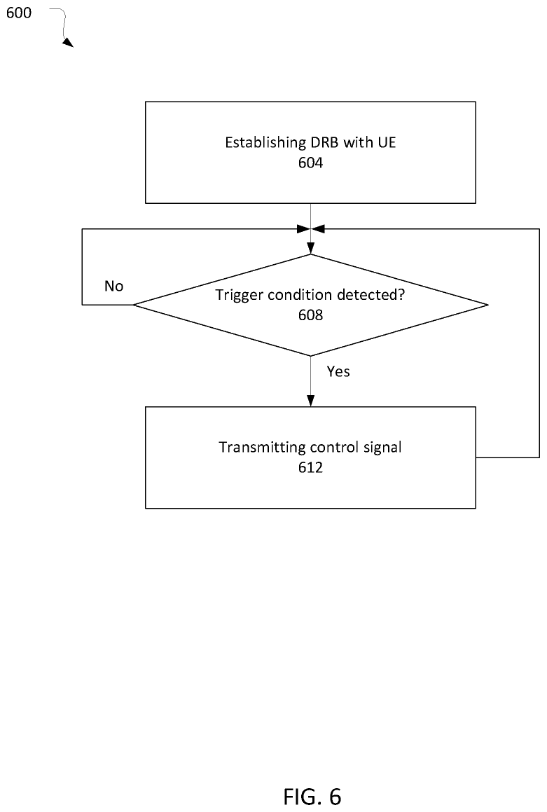

FIG. 6 is an operation flow/algorithmic structure 600 in accordance with some embodiments. The operation flow/algorithmic structure 600 may be performed by a base station such as base station 108, base station 900; or components thereof, for example, processors 904.

The operation flow/algorithmic structure 600 may include, at 604, establishing a DRB with a UE. The DRB may be established for transmission of PDU sets of an application service flow. This may be for streaming traffic such as XR traffic, for example. In some embodiments, a plurality of DRBs may be established for the PDU sets of the application service flow.

In some embodiments, the base station may provide configuration information to the UE to configure the UE for operation with respect to first and second handling modes. The first handling mode may correspond to a best-user experience PDU set handling mode in which a transmitter of the UE is to transmit all packets of PDU sets. The second handling mode may correspond to a resource-saving PDU set handling mode in which the transmitter is to transmit a subset of packets of the individual PDU sets.

The configuration information may provide one or more handling mode configurations. The one or more handling mode configurations may include, for example, an initial configuration that the UE is to use as a default configuration unless explicitly instructed otherwise. A handling mode configuration may provide an association of individual PDU sets with the first or second handling mode. For example, a configuration may provide that all PDU sets of a DRB/QOS flow are associated with the first or second PDU set handling mode. In another example, a configuration may provide that some PDU sets are associated with the first PDU set handling mode (for example, type 1 PDU sets) while other PDU sets (for example, type 2 PDU sets) are associated with the second PDU set handling mode.

The configuration information may additionally/alternatively provide threshold information that the UE may use to determine the set of packets of individual PDU sets that are to be transmitted in the second handling mode. For example, the threshold information may provide an indication of a number of packets that need to be transmitted or identify specific essential packets that need to be transmitted.

The operation flow/algorithmic structure 600 may further include, at 608, detecting for a trigger condition. A trigger condition may be detected based on one or more events detectable by the base station. These events may be similar to those described elsewhere herein and may be based on, for example, a RAN loading status, an interference status, or a channel status. A trigger condition may be associated with one or more of these statuses becoming greater (or less) than a corresponding threshold level.

The operation flow/algorithmic structure 600 may further include, at 612, transmitting a control signal to the UE. The control signal may include instructions to cause the UE to transition from a first configuration to a second configuration. The control signal, which may be an RRC signal or MAC CE as described elsewhere herein, may instruct the UE to switch from a first handling mode to a second handling mode for at least some of the PDU sets of a DRB/QOS flow. In some embodiments, the switched-to configuration may not be a predefined configuration. Rather, the control signal may simply provide an instruction to change the handling mode for at least one PDU set, which results in the switched-to configuration. In other embodiments, the switched-to configuration may be predefined and the control signal may simply reference the configuration to which the UE is to switch. In this instance, the UE will update the handling modes for the various PDU sets in order to match the predefined configuration.

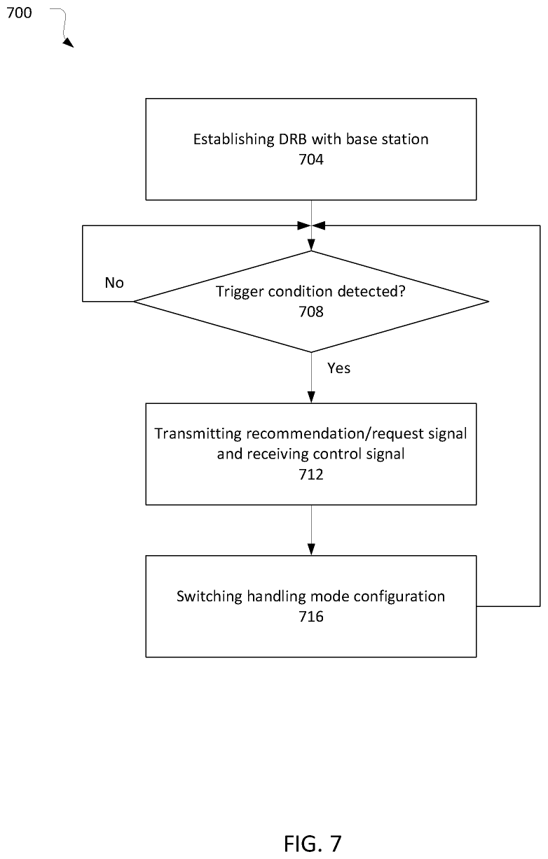

FIG. 7 is an operation flow/algorithmic structure 700 in accordance with some embodiments. The operation flow/algorithmic structure 700 may be performed by a UE such as UE 104, UE 800; or components thereof, for example, processors 804.

The operation flow/algorithmic structure 700 may include, at 704, establishing a DRB with a base station. The DRB may be established for transmission of PDU sets of an application service flow. This may be for streaming traffic such as XR traffic, for example. In some embodiments, a plurality of DRBs may be established for the PDU sets of the application service flow.

In some embodiments, the UE may receive configuration information from the base station that configures the UE for operation with respect to first and second handling modes. The configuration information may be similar to that described above with respect FIG. 6 in accordance with some embodiments. In some embodiments, the configuration information may additionally/alternatively provide information to configure a trigger condition. The information may include one or more events and corresponding threshold levels that are associated with a trigger condition.

The operation flow/algorithmic structure 700 may further include, at 708, detecting for a trigger condition. A trigger condition may be detected based on one or more events detectable by the UE. These events may be similar to those described elsewhere herein and may be based on, for example, a battery level status, a mobility status, a channel metric status, an interference level status, a location status of the UE, or a user input status (for example, a request to transition to a lower resolution video). A trigger condition may be associated with one or more of these statuses becoming greater (or less) than a corresponding threshold level.

Upon detection of the trigger condition at 708, the operation flow/algorithmic structure 700 may include, at 712, transmitting a recommendation/request signal to the base station to request to transition to a new handling mode configuration and receiving a response control signal. The recommendation/request may include one or more DRB identities associated with the request, one or more PDU sets associated with the request, or a reason associated with the request. The control signal may include instructions to cause the UE to transition from a first configuration to a second configuration. The control signal, which may be an RRC signal or MAC CE as described elsewhere herein, may instruct the UE to switch from a first handling mode to a second handling mode for at least some of the PDU sets of a DRB/QOS flow. Similar to the discussion above with respect to FIG. 6, the switched-to configuration may either be predefined configuration or may be the result of changing a handling mode for at least one PDU set.

The operation flow/algorithmic structure 700 may further include, at 716, switching the handling mode configuration. The UE may proceed to process further PDU sets of the application service flow based on the associations of the PDU sets to the different modes as defined by the switched-to configuration.

In some embodiments, the operation flow/algorithmic structure 700 may not include the transmitting of the recommendation/request signal and receiving the responsive control signal at 712. Instead, the UE may, upon detecting the trigger condition, advance to switching the handling mode configuration at 716. This may, in some instances, be followed by transmission of a notification signal to the base station to indicate the switch that resulted in the new handling mode configuration.

FIG. 8 illustrates an example UE 800 in accordance with some embodiments. The UE 800 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 800 may include processors 804, RF interface circuitry 808, memory/storage 812, user interface 816, sensors 820, driver circuitry 822, power management integrated circuit (PMIC) 824, antenna structure 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 832, which may represent any type of interface, input/output, bus (local, system, or expansion), transmission line, trace, optical connection, etc. that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein.

In some embodiments, the baseband processor circuitry 804A may access a communication protocol stack 836 in the memory/storage 812 to communicate over a 3GPP compatible network. In general, the baseband processor circuitry 804A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 812 may include one or more non-transitory, computer-readable media that includes instructions (for example, communication protocol stack 836) that may be executed by one or more of the processors 804 to cause the UE 800 to perform various operations described herein. The memory/storage 812 include any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 808 may include transceiver circuitry and radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 826 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 826.

In various embodiments, the RF interface circuitry 808 may be configured to transmit/receive signals in a manner compatible with NR access technologies.

The antenna 826 may include antenna elements to convert electrical signals into radio waves to travel through the air and to convert received radio waves into electrical signals. The antenna elements may be arranged into one or more antenna panels. The antenna 826 may have antenna panels that are omnidirectional, directional, or a combination thereof to enable beamforming and multiple-input, multiple-output communications. The antenna 826 may include microstrip antennas, printed antennas fabricated on the surface of one or more printed circuit boards, patch antennas, phased array antennas, etc. The antenna 826 may have one or more panels designed for specific frequency bands including bands in FR1 or FR2.

The user interface circuitry 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various input/output (I/O) devices that may be present within, or connected to, the UE 800. For example, driver circuitry 822 may include a display driver to control and allow access to a display device, a touchscreen driver to control and allow access to a touchscreen interface, sensor drivers to obtain sensor readings of sensor circuitry 820 and control and allow access to sensor circuitry 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

In some embodiments, the PMIC 824 may control, or otherwise be part of, various power saving mechanisms of the UE 800. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 800 may power down for brief intervals of time and thus save power. If there is no data traffic activity for an extended period of time, then the UE 800 may transition off to an RRC_Idle state, where it disconnects from the network and does not perform operations such as channel quality feedback, handover, etc.

The UE 800 goes into a very low power state and it performs paging where again it periodically wakes up to listen to the network and then powers down again. The UE 800 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 828 may power the UE 800, although in some examples the UE 800 may be mounted deployed in a fixed location, and may have a power supply coupled to an electrical grid. The battery 828 may be a lithium ion battery, a metal-air battery, such as a zinc-air battery, an aluminum-air battery, a lithium-air battery, and the like. In some implementations, such as in vehicle-based applications, the battery 828 may be a typical lead-acid automotive battery.

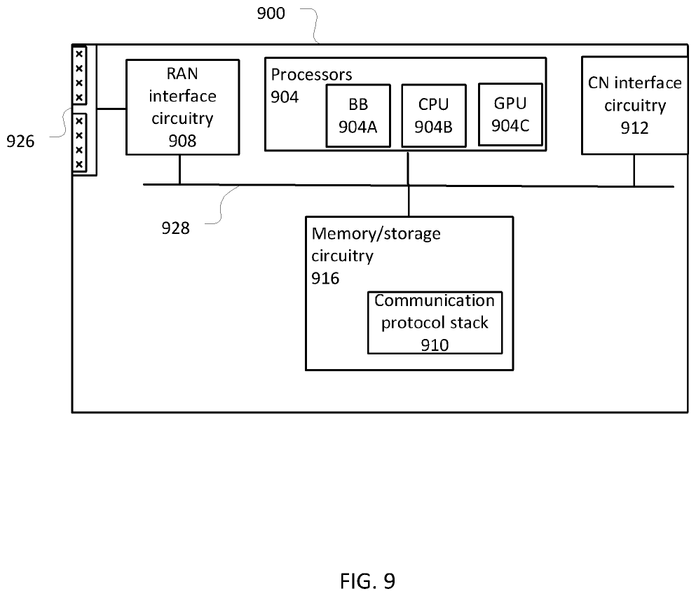

FIG. 9 illustrates an example base station 900 in accordance with some embodiments. The base station 900 may be a base station or an AMF as describe elsewhere herein. The base station 900 may include processors 904, RF interface circuitry 908, core network (CN) interface circuitry 912, memory/storage circuitry 916, and antenna structure 926. The RF interface circuitry 908 and antenna structure 926 may not be included when the base station 900 is an AMF.

The components of the base station 900 may be coupled with various other components over one or more interconnects 928.

The processors 904, RF interface circuitry 908, memory/storage circuitry 916 (including communication protocol stack 910), antenna structure 926, and interconnects 928 may be similar to like-named elements shown and described with respect to FIG. 8.

The CN interface circuitry 912 may provide connectivity to a core network, for example, a 5th Generation Core network (5GC) using a 5GC-compatible network interface protocol such as carrier Ethernet protocols, or some other suitable protocol.

Network connectivity may be provided to/from the base station 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a base station, the method comprising: detecting a trigger condition; and transmitting, based on detecting the trigger condition, a control signal to a user equipment (UE), the control signal to instruct the UE to switch from a first handling mode configuration to a second handling mode configuration, wherein: the first handling mode configuration provides a first association of individual protocol data unit (PDU) sets of a plurality of PDU sets of an application service flow with a first PDU set handling mode in which a transmitter of the UE is to transmit all packets of the individual PDU sets on at least one radio bearer or a second PDU set handling mode in which the transmitter is to transmit a subset of packets of the individual PDU sets on at least one radio bearer; and the second handling mode configuration provides a second association of the individual PDU sets of the plurality of PDU sets with the first PDU set handling mode or the second PDU set handling mode.

Example 2 includes a method of example 1 or some other example herein, further comprising: transmitting, to the UE, information to configure the first or second handling mode configurations.

Example 3 includes the method of example 1 or some other example herein, further comprising: transmitting, to the UE, an indication of a threshold to define the subset of packets of the individual PDU sets to be transmitted in the second PDU set handling mode.

Example 4 includes a method of example 1 or some other example herein, wherein the first handling mode configuration is an initial configuration in which all of the plurality of PDU sets are associated with the first PDU set handling mode.

Example 5 includes the method of example 1 or some other example herein, wherein the second association provided by the second handling mode configuration associates all of the plurality of PDU sets with the first PDU set handling mode or the second PDU set handling mode.

Example 6 includes a method of example 1 or some other example herein, wherein the plurality of PDU sets includes PDU sets of a first type and PDU sets of a second type and the second association provided by the second handling mode configuration associates the PDU sets of the first type with the first PDU set handling mode and associates the PDU sets of the second type with the second PDU set handling mode.

Example 7 includes a method of example 6 or some other example herein, wherein the first type is associated with a first priority or importance level and the second type is associated with a second priority or importance level that is less than the first priority or importance level.

Example 8 includes method of example 1 or some other example herein, further comprising: detecting the trigger based on a network loading status, an interference status, a channel quality, a location of the UE, or a mobility of the UE.

Example 9 includes a method of example 1 or some other example herein, wherein the control signal comprises a radio resource control (RRC) reconfiguration message or a downlink media access control-control element (MAC-CE).

Example 10 includes the method of example 1 or some other example herein, further comprising: establishing a plurality of data radio bearers (DRBs) with the UE, wherein the control signal is to instruct the UE to use the first PDU set handling mode or the second PDU set handling mode for individual DRBs of the plurality of DRBs.

Example 11 includes the method of example 10 or some other example herein, wherein the control signal comprises: a bitmap with a plurality of bits that respectively correspond to the plurality of DRBs, wherein a value of individual bits of the plurality of bits is to indicate that the UE is to use either the first PDU set handling mode or the second PDU set handling mode for a corresponding DRB; or one or more identities associated with one or more DRBs for which the UE is to switch PDU set handling modes.

Example 12 includes a method of operating a UE, the method comprising: receiving, from the base station, a control signal to instruct the UE to switch from a first handling mode configuration to a second handling mode configuration, wherein: the first handling mode configuration provides a first association of individual protocol data unit (PDU) sets of a plurality of PDU sets of an application service flow with a first PDU set handling mode in which a transmitter of the UE is to transmit all packets of the individual PDU sets on at least one radio bearer or a second PDU set handling mode in which the transmitter is to transmit a subset of packets of the individual PDU sets on at least one radio bearer; and the second handling mode configuration provides a second association of the individual PDU sets of the plurality of PDU sets with the first PDU set handling mode or the second PDU set handling mode; and switching to the second handling mode configuration.

Example 13 includes a method of example 12 or some other example herein, further comprising: receiving, from the base station, information to configure the first or second handling mode configurations.

Example 14 includes the method of example 12 or some other example herein, further comprising: receiving, from the base station, an indication of a threshold to define the subset of packets of the individual PDU sets to be transmitted in the second PDU set handling mode.

Example 15 includes a method of example 12 or some other example herein, wherein the first handling mode configuration is an initial configuration in which all of the plurality of PDU sets are associated with the first PDU set handling mode.

Example 16 includes the method of example 12 or some other example herein, wherein the second association provided by the second handling mode configuration associates all of the plurality of PDU sets with the first PDU set handling mode or the second PDU set handling mode.

Example 17 includes the method of example 12 or some other example herein, wherein the plurality of PDU sets includes PDU sets of a first type and PDU sets of a second type and the second association provided by the second handling mode configuration associates the PDU sets of the first type with the first PDU set handling mode and associates the PDU sets of the second type with the second PDU set handling mode.

Example 18 includes the method of example 17 or some other example herein, wherein the first type is associated with a first priority and the second type is associated with a second priority that is less than the first priority.

Example 19 includes the method of example 12 or some other example herein, further comprising: establishing a plurality of data radio bearers (DRBs) with the base station, wherein the control signal is to instruct the UE to use the first PDU set handling mode or the second PDU set handling mode for individual DRBs of the plurality of DRBs.

Example 20 includes the method of example 19 or some other example herein, wherein the control signal comprises: a bitmap with a plurality of bits that respectively correspond to the plurality of DRBs, wherein a value of individual bits of the plurality of bits is to indicate that the UE is to use either the first PDU set handling mode or the second PDU set handling mode for a corresponding DRB; or one or more identities associated with one or more DRBs for which the UE is to switch PDU set handling modes.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. A method comprising:
detecting a trigger condition; and
outputting, based on detecting the trigger condition, a control signal for transmission to a user equipment (UE), the control signal to instruct the UE to switch from a first handling mode configuration to a second handling mode configuration,
wherein:
the first handling mode configuration provides a first association of individual protocol data unit (PDU) sets of a plurality of PDU sets of an application service flow with a first PDU set handling mode in which a transmitter of the UE is to transmit all packets of the individual PDU sets on at least one radio bearer or a second PDU set handling mode in which the transmitter is to transmit a subset of packets of the individual PDU sets on at least one radio bearer; and
the second handling mode configuration provides a second association of the individual PDU sets of the plurality of PDU sets with the first PDU set handling mode or the second PDU set handling mode.

22. The method of claim 21, further comprising:
outputting, for transmission to the UE, information to configure the first or second handling mode configurations.

23. The method of claim 21, further comprising:
outputting, for transmission to the UE, an indication of a threshold to define the subset of packets of the individual PDU sets to be transmitted in the second PDU set handling mode.

24. The method of claim 21, wherein the first handling mode configuration is an initial configuration in which all of the plurality of PDU sets are associated with the first PDU set handling mode.

25. The method of claim 21, wherein the second association provided by the second handling mode configuration associates all of the plurality of PDU sets with the first PDU set handling mode or the second PDU set handling mode.

26. The method of claim 21, wherein the plurality of PDU sets includes PDU sets of a first type and PDU sets of a second type and the second association provided by the second handling mode configuration associates the PDU sets of the first type with the first PDU set handling mode and associates the PDU sets of the second type with the second PDU set handling mode.

27. The method of claim 26, wherein the first type is associated with a first priority or importance level and the second type is associated with a second priority or importance level that is less than the first priority or importance level.

28. The method of claim 21, further comprising:
detecting the trigger condition based on a network loading status, an interference status, a channel quality, a location of the UE, or a mobility of the UE.

29. The method of claim 21, wherein the control signal comprises a radio resource control (RRC) reconfiguration message or a downlink media access control-control element (MAC-CE).

30. One or more non-transitory, computer-readable media having instructions that, when executed, cause processor circuitry to:
detect a trigger condition; and
output, based on detecting the trigger condition, a control signal for transmission to a user equipment (UE), the control signal to instruct the UE to switch from a first handling mode configuration to a second handling mode configuration, wherein:
the first handling mode configuration provides a first association of individual protocol data unit (PDU) sets of a plurality of PDU sets of an application service flow with a first PDU set handling mode in which a transmitter of the UE is to transmit all packets of the individual PDU sets on at least one radio bearer or a second PDU set handling mode in which the transmitter is to transmit a subset of packets of the individual PDU sets on at least one radio bearer; and
the second handling mode configuration provides a second association of the individual PDU sets of the plurality of PDU sets with the first PDU set handling mode or the second PDU set handling mode.

31. The one or more non-transitory, computer-readable media of claim 30, wherein the instructions, when executed, further cause the processor circuitry to:
establish a plurality of data radio bearers (DRBs) with the UE, wherein the control signal is to instruct the UE to use the first PDU set handling mode or the second PDU set handling mode for individual DRBs of the plurality of DRBs. and the control signal includes:
a bitmap with a plurality of bits that respectively correspond to the plurality of DRBs, wherein a value of individual bits of the plurality of bits is to indicate that the UE is to use either the first PDU set handling mode or the second PDU set handling mode for a corresponding DRB;
or one or more identities associated with one or more DRBs for which the UE is to switch PDU set handling modes.

32. A method comprising:
receiving, from a base station, a control signal to instruct a user equipment (UE) to switch from a first handling mode configuration to a second handling mode configuration, wherein:
the first handling mode configuration provides a first association of individual protocol data unit (PDU) sets of a plurality of PDU sets of an application service flow with a first PDU set handling mode in which a transmitter of the UE is to transmit all packets of the individual PDU sets on at least one radio bearer or a second PDU set handling mode in which the transmitter is to transmit a subset of packets of the individual PDU sets on at least one radio bearer; and
the second handling mode configuration provides a second association of the individual PDU sets of the plurality of PDU sets with the first PDU set handling mode or the second PDU set handling mode; and
switching to the second handling mode configuration.

33. The method of claim 32, further comprising:
receiving, from the base station, information to configure the first or second handling mode configurations.

34. The method of claim 32, further comprising:
receiving, from the base station, an indication of a threshold to define the subset of packets of the individual PDU sets to be transmitted in the second PDU set handling mode.

35. The method of claim 32, wherein the first handling mode configuration is an initial configuration in which all of the plurality of PDU sets are associated with the first PDU set handling mode.

36. The method of claim 32, wherein the second association provided by the second handling mode configuration associates all of the plurality of PDU sets with the first PDU set handling mode or the second PDU set handling mode.

37. The method of claim 32, wherein the plurality of PDU sets includes PDU sets of a first type and PDU sets of a second type and the second association provided by the second handling mode configuration associates the PDU sets of the first type with the first PDU set handling mode and associates the PDU sets of the second type with the second PDU set handling mode.

38. The method of claim 37, wherein the first type is associated with a first priority and the second type is associated with a second priority that is less than the first priority.

39. The method of claim 32, further comprising:
establishing a plurality of data radio bearers (DRBs) with the base station, wherein the control signal is to instruct the UE to use the first PDU set handling mode or the second PDU set handling mode for individual DRBs of the plurality of DRBs.

40. The method of claim 39, wherein the control signal comprises:
a bitmap with a plurality of bits that respectively correspond to the plurality of DRBs, wherein a value of individual bits of the plurality of bits is to indicate that the UE is to use either the first PDU set handling mode or the second PDU set handling mode for a corresponding DRB; or
one or more identities associated with one or more DRBs for which the UE is to switch PDU set handling modes.
